(19) United States
(12) Patent Application Publication
(10) Pub. No.: US 2026/0093112 A1
(43) Pub. Date: Apr. 2, 2026

(54) DISPLAY MODULE AND DISPLAY SYSTEM INCLUDING THE SAME

(71) Applicant: AUO Corporation, Hsinchu City (TW)

(72) Inventors: Yen-Ju HUANG, Hsinchu City (TW); Chia-Hung Chen, Hsinchu City (TW); Yueh-Heng Lee, Hsinchu City (TW); Hsuan-Jui Peng, Hsinchu City (TW)

(21) Appl. No.: 19/006,960

(22) Filed: Dec. 31, 2024

(30) Foreign Application Priority Data
Sep. 27, 2024 (TW) 113136881

(51) Int. Cl. G02B 27/01

(52) U.S. Cl. CPC G02B 27/0101

(57) ABSTRACT

The present invention provides a display module and a display system including the same. The display module includes: a backlight module; a first prism layer, disposed on the backlight module and having a plurality of first prismatic structures extending along a first direction; a second prism layer, disposed on the first prism layer and having a plurality of second prismatic structures extending along a second direction transverse to the first direction; and a display panel, disposed on the second prism layer. The first prismatic structure protrudes away from the backlight module and has a first prismatic section that is triangular on a virtual plane in which the normal direction is the first direction. The second prismatic structure protrudes away from the backlight module and has a second prismatic section that is triangular on a virtual plane in which the normal direction is the second direction. The vertex of the second prismatic section has a vertical projection onto a base edge of the second prismatic section which is offset along the first direction relative to a center of the base edge.

### CROSS-REFERENCE TO RELATED APPLICATION

This application claims the priority benefit of Taiwan application serial no. 113136881 filed on Sep. 27, 2024. The entirety of the above-mentioned patent applications is hereby incorporated by reference herein and made a part of this specification.

### TECHNICAL FIELD

The present invention relates to a display module and a display system including the same. Specifically, the present invention relates to a display module having a first prism layer and a second prism layer, and a display system including the display module.

### BACKGROUND

With the rapid development of modern display technology, various application fields of display devices are gradually increasing and expanding. As mentioned above, a head-up display (HUD) that can be integrated into a transportation vehicle can provide display information on the premise of ensuring the driving field of view of a driver, and thus the frequency and time of viewing the display device with the head down can be reduced. Therefore, in order to provide safer and more convenient operation, such novel interfaces are gradually becoming the mainstream of vehicle-mounted display devices. However, due to the limitations of vehicle space or design architecture, such head-up displays may have disadvantages that the display area is excessively low, the display brightness is excessively low, the display information is limited, display objects are limited or the like, so that it is difficult and/or inconvenient for the driver and/or passengers to read the information. Therefore, in order to improve the convenience and operability of the driver and/or passengers, and to facilitate the real-time grasp of various types of information, such as driving speed, navigation instructions, driving status, hardware status, power and/or fuel level, danger warnings, it is necessary to develop a head-up display that can improve the display quality, display effect and display range, and can be integrated into the transportation vehicle based on a reduced size.

### SUMMARY

In order to solve the above problem, according to an embodiment of the present invention, provided is a display module, including: a backlight module; a first prism layer, disposed on the backlight module and having a plurality of first prismatic structures extending along a first direction; a second prism layer, disposed on the first prism layer and having a plurality of second prismatic structures extending along a second direction transverse to the first direction, where the first prismatic structures and the second prismatic structures protrude away from the backlight module; and a display panel, disposed on the second prism layer. Each of the first prismatic structures has a first prismatic section on a virtual plane in which the normal direction is the first direction, and each of the second prismatic structures has a second prismatic section on a virtual plane in which the normal direction is the second direction. The first prismatic section and the second prismatic section are triangles. The vertex of the second prismatic section has a vertical projection onto the base edge of the second prismatic section which is offset along the first direction relative to a center of a base edge.

According to another embodiment of the present invention, provided is a display system, including: a transparent plate, having at least partial reflectivity; the display module as described above, where the display module is disposed on a first side of the transparent plate, and the display panel forms an acute angle with the transparent plate; and a observation region, located on the first side of the transparent plate and farther away from the transparent plate than the display module. The first direction runs through the transparent plate. At least part of image light rays emitted by the display panel reach the observation region by reflection by the transparent plate, and ambient light rays located on a second side of the transparent plate reach the observation region by being at least partially incident through the transparent plate.

According to the display module and display system provided in various embodiment of the present invention, based on the arrangement of the first prism layer and the second prism layer, the amount of the emergent light biased in a preset direction can be further increased, and the degree of divergence of the emergent light can be correspondingly increased. As mentioned above, according to the display module and display system of various embodiments of the present invention, the divergent emergent light can be reflected by the transparent plate which forms a preset angle with the display module, and a loss of emergent light away from the preset direction, for example, a loss generated by directly passing through the transparent plate, can be reduced or avoided. Therefore, according to the display module and display system provided by various embodiments of the present invention, light rays of divergence property emitted by the display module and biased towards a preset direction can be brightened, and a wide-area virtual image with enhanced brightness and uniformity can be further presented by the light rays passing through the transparent plate with perspectivity and reflectivity.

### BRIEF DESCRIPTION OF THE DRAWINGS

FIG. 1 is an exploded schematic diagram of a display module according to an embodiment of the present invention.

FIG. 2 is a cross-sectional schematic diagram of a first prism layer according to an embodiment of the present invention.

FIG. 3 is a cross-sectional schematic diagram of a second prism layer according to an embodiment of the present invention.

FIG. 4 is a schematic diagram showing divergence and offset generated by an emission light field of emergent light passing through a first prism layer and a second prism layer according to different embodiments of the present invention.

FIG. 5 is a schematic diagram comparing differences in viewing angles of emission light fields of original emergent light an offset emergent light according to an embodiment of the present invention.

FIG. 6 is a cross-sectional schematic diagram of a display module and its emergent light viewing angle according to an embodiment of the present invention.

FIG. 7 is a schematic diagram of application of a display system including a display module according to yet another embodiment of the present invention.

FIG. 8 is a specific schematic diagram of a configuration direction of a first prism layer and a second prism layer in a display system according to yet another embodiment of the present invention.

FIG. 9 is a schematic diagram of application of a display system performing wide-area display according to still another embodiment of the present invention.

### DETAILED DESCRIPTION

Various embodiments will be described below, and those skilled in the art should be able to easily understand the spirit and principles of the present invention by referring to description with schematics. However, although specific embodiments will be specified herein, these embodiments are only illustrative and are not considered restrictive or exhaustive in all aspects. Therefore, for those skilled in the art, without departing from the spirit and principle of the present invention, the various changes and modifications of the present invention should be obvious and easily achieved.

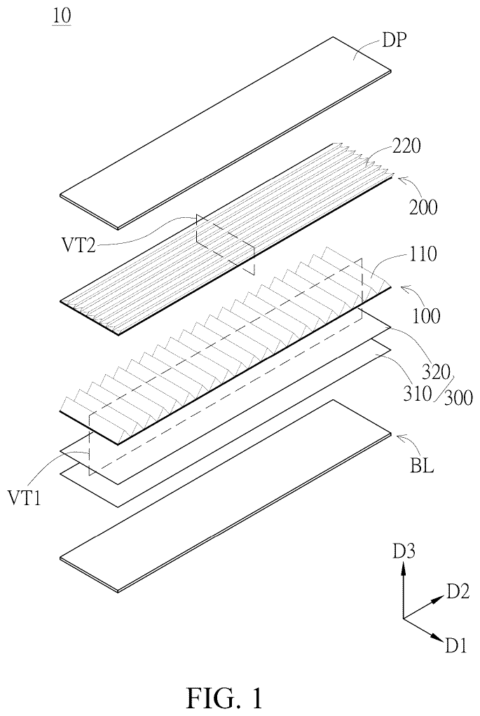

Referring to FIG. 1, according to an embodiment of the present invention, provided is a display module 10, including: a backlight module BL used for generating light rays, a first prism layer 100 disposed on the backlight module BL, a second prism layer 200 disposed on the first prism layer 100, and a display panel DP disposed on the second prism layer 200 and used for generating or configuring image light rays. In addition, according to some embodiments of the present invention, other optical elements 300 may also be further configured according to the design of the display module 10. For example, optical elements such as a first optical layer 310 as a light guide plate and a second optical layer 320 as a light diffuser may be further disposed between the backlight module BL and the first prism layer 100 to adjust the emergent light property or emergent light pattern of the backlight module BL. However, the description herein is only illustrative, and in addition to the pattern specifically depicted in FIG. 1, those skilled in the art can arrange or adjust the optical element 300 so as to integrate the optical element into an expected position of the display module 10 of the present invention according to other needs or designs, and these possible changes and details will not be repeated herein.

As mentioned above, according to the present embodiment, the first prism layer 100 may have a plurality of first prismatic structures 110 extending along a first direction D1, and the second prism layer 200 may have a plurality of second prismatic structures 220 extending along a second direction D2 transverse to the first direction D1. By way of examples, extension directions of the first prismatic structures 110 and the second prismatic structures 220 may be perpendicular to each other. That is, the first prismatic structures 110 of the first prism layer 100 and the second prismatic structures 220 of the second prism layer 200 are configured to be disposed orthogonally to each other.

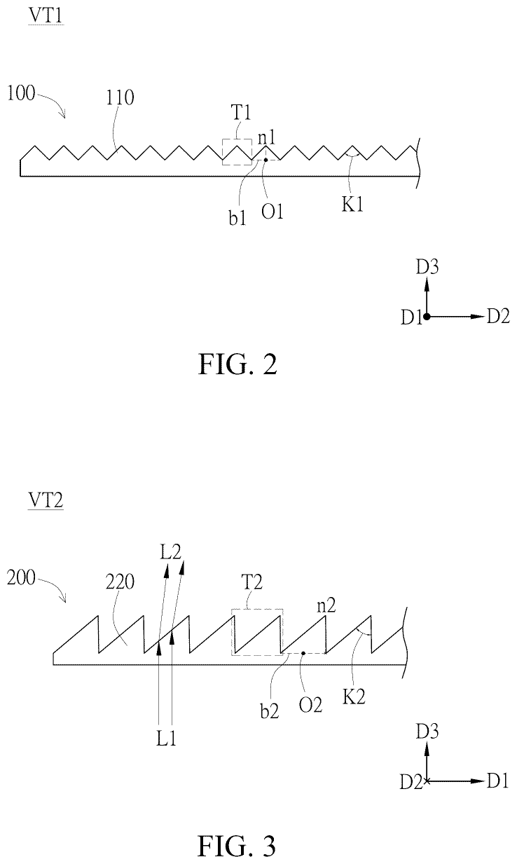

Referring to FIG. 1 further, both the first prismatic structure 110 and the second prismatic structure 220 protrude away from the backlight module BL. For example, both the first prismatic structure 110 and the second prismatic structure 220 may protrude away from the backlight module BL along a third direction D3. Specifically, referring to FIGS. 2 and 3 along with FIG. 1, each of the first prismatic structures 110 has a first prismatic section T1 on a virtual plane VT1 in which the normal direction is the first direction D1, and each of the second prismatic structures 220 has a second prismatic section T2 on a virtual plane VT2 in which the normal direction is the second direction D2. As mentioned above, as shown in the enlarged sections of FIGS. 2 and 3, the first prismatic section T1 and the second prismatic section T2 may both be triangles protruding away from the backlight module BL. For example, the first prismatic structure 110 and the second prismatic structure 220 each may be a strip-shaped extended column with a triangular section and protruding away from the backlight module BL.

Specifically, according to some embodiments, the first prismatic section T1 may be formed into an essentially symmetrical triangle, and the second prismatic section T2 may be formed into an essentially asymmetrical triangle. For example, as shown in the local section of the virtual plane VT1 in FIG. 2, the first prismatic section T1 may be an isosceles triangle, so that the vertex n1 of the first prismatic section T1 corresponds to the center O1 of the base edge bl when vertically projected onto the base edge b1 of the first prismatic section T1. As mentioned above, according to some embodiments, the first prismatic section T1 may have a vertex angle K1, and the vertex angle K1 may be an acute angle, a right angle or an obtuse angle. By way of examples, according to the process tolerance limit, the vertex angle K1 may have an angle falling within the range from 30 degrees to 150 degrees. Alternatively, the vertex angle K1 may have an angle falling within the range from 60 degrees to 120 degrees. For example, as shown in FIG. 2, the vertex angle K1 may be 90 degrees, but this is only an example and it is not limited to this according to other embodiments.

In contrast, as shown in the local section of the virtual plane VT2 in FIG. 3, the second prismatic section T2 may be an asymmetrical acute triangle. The vertex angle K2 of the second prismatic section T2 may be at least less than 90 degrees. For example, the vertex angle K2 of the second prismatic section T2 may be less than 60 degrees. Further, according to some embodiments of the present invention, in order to achieve an expected brightness gain, the vertex angle K2 of the second prismatic section T2 may be less than 45 degrees. As mentioned above, the second prismatic section T2 is not symmetrically formed, and thus, the vertex n2 of the second prismatic section T2 has a vertical projection onto the base edge b2 of the second prismatic section T2 which may be offset relative to the center O2 of the base edge b2. By way of examples, the vertex n2 of the second prismatic section T2 has a vertical projection onto the base edge b2 of the second prismatic section T2 which may be offset along the first direction D1 relative to the center O2 of the base edge b2. Therefore, triangular column bars of the second prismatic structures 220 can slant relatively along the first direction D1.

According to some embodiments, as shown in FIG. 3, when a light ray L1 exiting through the first prism layer 100 further passes through the second prism layer 200, a light ray L2 being offset along the first direction D1 can be generated relatively based on this structure. Specifically, referring to FIGS. 1 to 3, emergent light from the backlight module BL can at least partially bias in the first direction D1 when passing through the first prism layer 100 and the second prism layer 200 sequentially.

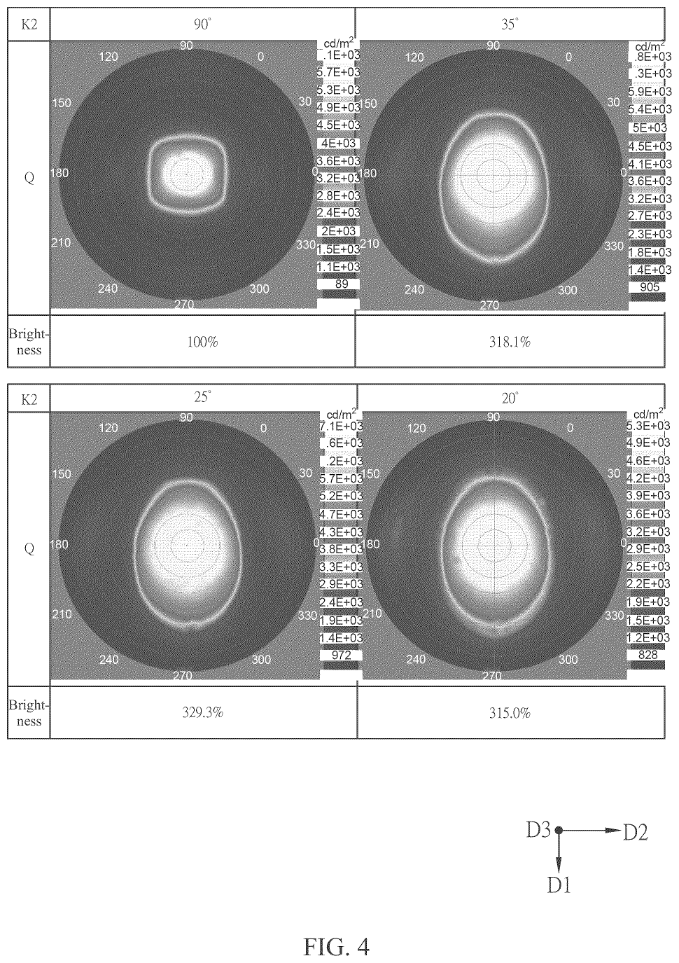

As mentioned above, referring to FIG. 4 further, a schematic diagram of the brightness of an emission light field Q actually biased by the first prism layer 100 and the second prism layer 200 is shown. Specifically, when the first prismatic structure 110 of the first prism layer 100 and the second prismatic structure 220 of the second prism layer 200 are disposed orthogonally based on the extension direction, the angle of the vertex angle K2 of the second prismatic section T2 of the second prismatic structure 220 of the second prism layer 200 can be changed, so that the second prismatic structure 220 is offset along the first direction D1. By way of examples, FIG. 4 shows that changes in the brightness of the emission light field Q of the same backlight module BL after passing through the first prism layer 100 and the second prism layer 200 sequentially in a case that the vertex angle K2 is 90 degrees (no offset), 35 degrees (positive offset along the first direction D1), 25 degrees (positive offset along the first direction D1), and 20 degrees (positive offset along the first direction D1). It can be seen that after the second prismatic structure 220 is positively offset along the first direction D1, the emission light field Q is also positively biased along the first direction D1, and may have a relatively scattering property by further divergence. That is, according to the present embodiment, a light spot can be further expanded or improved. As mentioned above, as shown in FIG. 4, according to the present embodiment, after the vertex angle K2 is less than 45 degrees, for example, at 35 degrees, 25 degrees and 20 degrees, there are relatively further divergent emission light fields Q and the brightness of overall vision can be even brightened to more than 300% in comparison with an unbiased pattern of reference (the vertex angle K2 is 90 degrees). In addition, it can be seen from FIG. 4 that the light pattern of the emission light field Q of the emergent light emitted by the backlight module BL and sequentially passing through the first prism layer 100 and the second prism layer 200 has a greater degree of divergence in the first direction D1 than in the second direction D2.

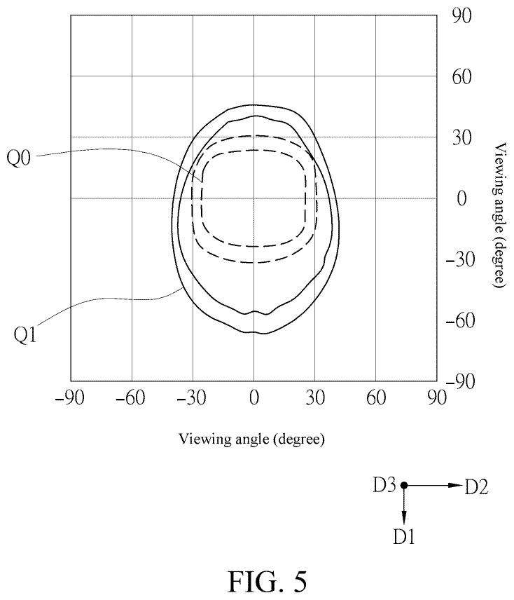

Further, according to the present embodiment, referring to FIG. 5 together with FIG. 4, under the bias of the second prismatic structure 220 along the first direction D1, the viewing angle of the emission light field Q of the emergent light emitted by the backlight module BL and sequentially passing through the first prism layer 100 and the second prism layer 200 can be correspondingly expanded relative to a vertical normal (corresponding to the improvement of the divergence property of the emission light field Q). Specifically, if the pattern of an emission light field Q0 with the vertex angle K2 of 90 degrees (no offset) and the pattern of an emission light field Q1 with the vertex angle K2 of 35 degrees (positive offset along the first direction D1) in FIG. 4 are compared, it can be seen that relative to centralized vertical emergent light, since the light field Q1 becomes more divergent and is biased along the first direction D1, the light field Q1 can further generate a wider range of emergent light viewing angles in addition to a vertical emergent light viewing angle (0 degree). That is, according to some embodiments, in a case that the second prismatic structure 220 is biased along the first direction D1 and is arranged such that the vertex angle K2 of the second prismatic structure 220 becomes smaller, an emission light field Q1 that is expanded and divergent can be generated, so that the emission light field Q1 may have a wider emergent light viewing angle range and have a larger half-power full angle.

By way of examples, according to the present embodiment, as shown in FIG. 5, in a case where the second prismatic structure 220 is biased along the first direction D1 and is arranged such that the vertex angle K2 of the second prismatic structure 220 becomes smaller, the half-power full angle of the emission light field Q1 of the emergent light emitted by the backlight module BL and sequentially passing through the first prism layer 100 and the second prism layer 200 may be greater than 30 degrees. Specifically, the viewing angle at half power of the emergent light with the maximum power of the emission light field Q1 may be, for example, greater than 30 degrees. Therefore, an observation object within a wider viewing angle can more easily receive the light rays emitted by the device of the present embodiment.

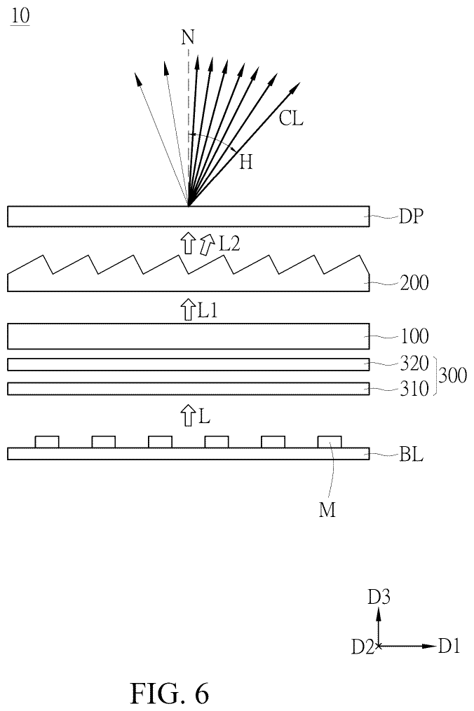

Specifically, referring to FIG. 6 further, the backlight module BL of display module 10 may emit a light ray L (for example, emitting light using densely disposed luminous sources M such as Mini LEDs, which is not limited to this). This light ray L can sequentially pass through the first prism layer 100 to generate a light ray LI concentrated in the second direction D2, and after the light ray L1 passes through the second prism layer 200, a light ray L2 that is biased in the first direction D1 and further diverges as described above can be generated.

As mentioned above, the display panel DP of the display module 10 may be various display panels that can perform display based on display unit configuration and electrical control by using backlight, and the divergent biased light ray L2 can be correspondingly used to generate an image light ray CL that displays expected image. As shown in FIG. 6, the image light ray CL performs display based on the biased light ray L2, and thus can be biased correspondingly in the first direction D1, and can have a wider emergent light viewing angle H relative to the vertical normal N of the display panel DP. By way of examples, according to some embodiments, the display panel DP itself may not have the function of biasing light rays, but based on the biased light ray L2, the image light ray CL that is biased and divergent in the first direction D1 can be generated, and thereby, a display image or information with enhanced brightness can be presented in an asymmetric form at an expected angle or direction. As mentioned above, based on the divergent biased light ray L2, the image light ray CL may be, for example, a larger amount of divergent emergent light that is offset in the positive direction of the first direction D1 relative to common symmetrical emergent light (for example but not limited to a Lambertian light emergence mode), and the display image or information with enhanced brightness can be presented correspondingly in the positive direction of the first direction D1. Therefore, according to the present embodiment, the display module 10 can implement display emergent light with bias and increased degree of divergence in an expected direction, such as the first direction D1, and thus various applications of emergent light bias and wide-area display can be carried out based on this. Furthermore, according to other embodiments of the present invention, the display module 10 may also be matched with or integrated with various display modules or other light ray biasing structures with the function of further biasing light rays to enhance the effect, thus facilitating various applications of emergent light bias and wide-area display.

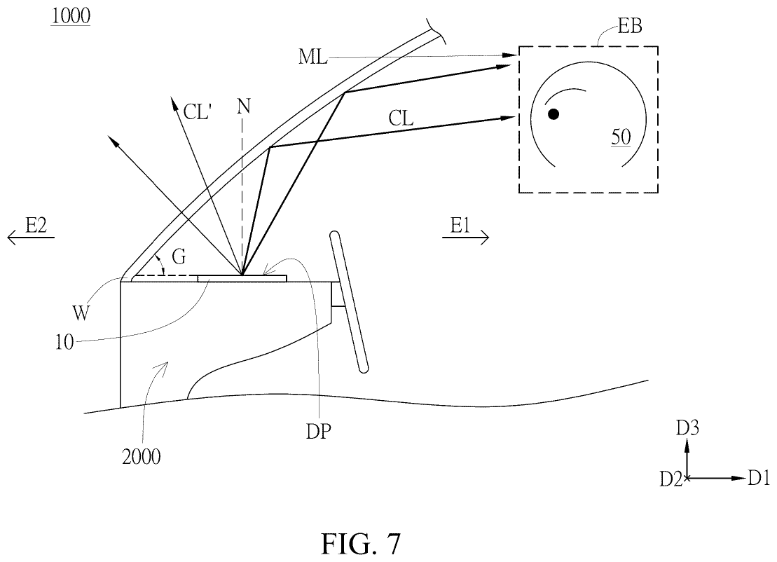

Next, referring to FIG. 7, an application scenario of the display module 10 will be further explained hereinafter based on the display system 1000 according to an embodiment of the present invention.

As mentioned above, according to the present embodiment, disclosed is a display system 1000, including a transparent plate W with at least partial reflectivity, a display module 10 disposed on a first side E1 of the transparent plate W, and a observation region EB located on the first side E1 of the transparent plate W as well. The observation region EB is farther away from the transparent plate W than the display module 10, and may be, for example, an observation region where an object using the display information of the display system 1000 is expected to be located. In addition, the display panel DP is disposed to form an acute angle G with the transparent plate W and emit the image light rays CL towards the transparent plate W. Therefore, at least part of the image light rays CL emitted from the display panel DP can be displayed towards the predicted observation region EB by reflection of the transparent plate W.

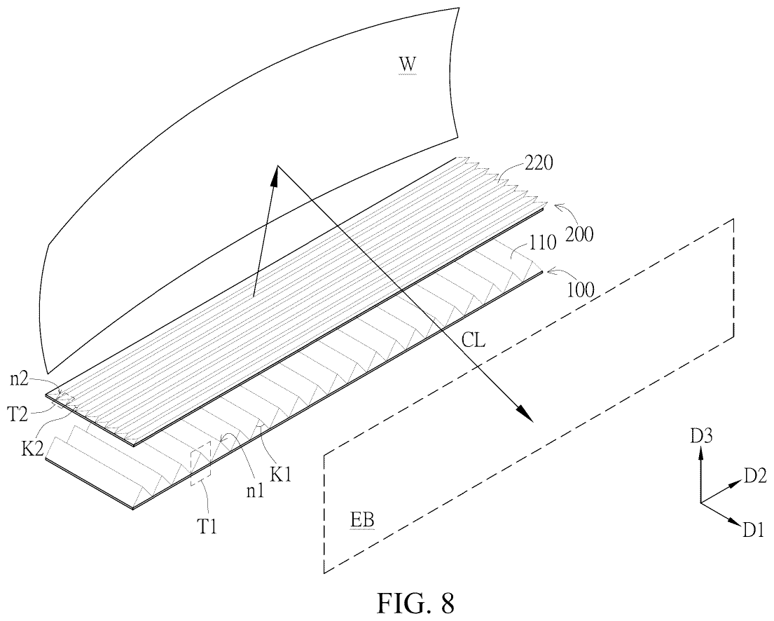

According to the present embodiment, the display module 10 may be the display module 10 specifically described above with reference to other figures, and the first direction D1 is a direction that correspondingly runs through the transparent plate W. For example, according to the present embodiment, the first direction D1 may be a direction that runs through the transparent plate W from a second side E2 of the transparent plate W to the first side E1 of the transparent plate W. As mentioned above, since the display module 10 can generate the image light ray CL that is biased in the first direction D1, e.g., in the positive direction of the first direction D1, the image light ray CL can be biased in the first direction D1 relative to the normal n of the display panel DP and exits at a larger viewing angle. Specifically, together with FIG. 7, referring to FIG. 8 which only partially illustrates the configuration of the first prism layer 100 and the second prism layer 200, the vertex n2 of the second prismatic section T2 may be offset along the first direction D1 away from the transparent plate W towards the observation region EB. As mentioned above, the vertex angle K2 of the second prismatic section T2 may be less than 90 degrees. For example, the vertex angle K2 of the second prismatic section T2 may be less than 45 degrees. With this architecture, the proportion of the image light rays CL biased towards the observation region EB along the first direction D1 and exiting towards the transparent plate W can be increased, thereby increasing the brightness of an image that can be presented by reflection by the transparent plate W.

Specifically, as shown in FIGS. 7 and 8, the image light ray CL exiting at a larger viewing angle can reach the observation region EB by reflection by the transparent plate W at a position closer to the observation region EB along the first direction D1. As mentioned above, according to the present embodiment, due to the bias in the first direction D1, the amount of emergent light of image light rays CL′ at a position farther away from the observation region EB along the first direction D1 can be reduced, and therefore, the emergent light that may be directly incident vertically or at a smaller inclination angle upon the transparent plate W due to the fact that the display panel DP forms the acute angle G with the transparent plate W can be reduced or avoided, and the emergent light that is incident upon the transparent plate W at a relatively large inclination angle along the surface of the transparent plate W and is then reflected is increased. As mentioned above, the image light rays CL′ emitted along the first direction D1 at a position farther away from the observation region EB, may be incident upon the transparent plate W vertically or incident upon the transparent plate W at a smaller inclination angle, and at least part of the image light rays CL′ may directly pass through the transparent plate W with light permeability and thus cannot be reflected to the observation region EB, thereby unexpectedly increasing a loss of the light rays and reducing the light emergence efficiency. Therefore, reducing the image light rays CL′ and increasing the image light rays CL biased towards the observation region EB along the first direction D1 can correspondingly increase the number of light rays reflected by being incident upon the transparent plate W with light permeability at a larger inclination angle, and thereby, the display brightness of the display module 10 observed in the observation region EB can be enhanced.

According to the present embodiment, at least part of image light rays CL emitted by the display panel DP can reach the observation region by reflection by the transparent plate W, and ambient light rays ML located on the second side E2 of the transparent plate W also can reach the observation region by being at least partially incident through the transparent plate W. Therefore, the observation region EB can obtain display information with enhanced brightness while ensuring a field of view of the other side (for example, the second side E2) of the transparent plate W.

According to some embodiments, the display system 1000 can be installed in an integrated manner into a transportation vehicle 2000 to serve as a head-up display (HUD) of the transportation vehicle. By way of examples, the transparent plate W may be a windshield of the transportation vehicle 2000, e.g., an automobile, and the observation region EB may be an observation region corresponding to the position of a driver 50.

According to the present embodiment, since it is similar to the above embodiments, the light pattern of the emission light field Q of the emergent light emitted by the backlight module BL and sequentially passing through the first prism layer 100 and the second prism layer 200 has a greater degree of divergence in the first direction D1 than in the second direction D2. For example, in the first direction D1, the half-power full angle of the emission light field Q of the emergent light emitted by the backlight module BL and sequentially passing through the first prism layer 100 and the second prism layer 200 may be greater than 30 degrees. Therefore, the display system 1000 according to the present embodiment may essentially have a divergent light field distribution with higher brightness and a wider viewing angle, so that other regions in addition to the observation region EB can also correspondingly obtain display information while ensuring the field of view of the other side (for example, the second side E2) of the transparent plate W.

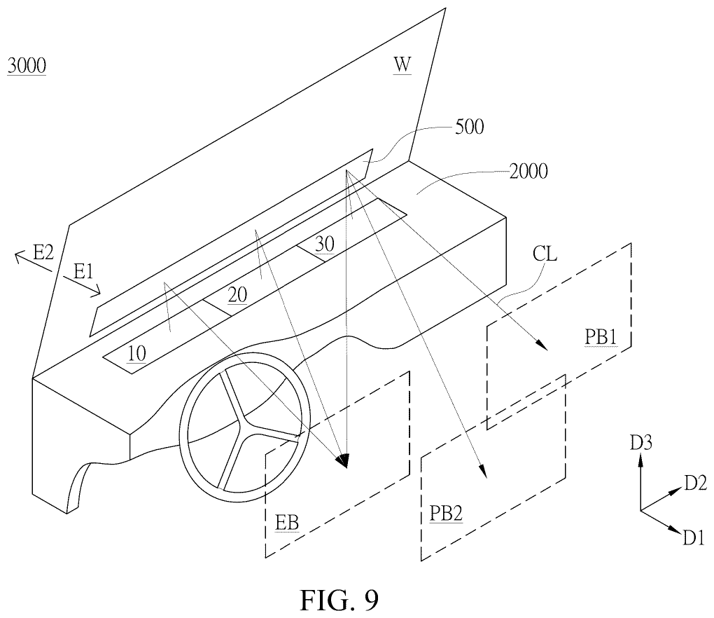

Specifically, as shown in FIG. 9, the display system 3000, which may have the same or similar architecture as the display system 1000, may serve as a pillar-to-pillar head-up display (PHUD). As mentioned above, the display system 3000 may have at least one display module 10. For example, as shown in FIG. 9, the display system 3000 may have the display modules 10, 20, and 30 disposed in a connected or separated manner, and may have a corresponding architecture of first prism layer and second prism layer that is similar or identical to that described with reference to other figures above. The display modules 10, 20, and 30 may be display modules separately configured, or may be different blocks of an integrated display module. As mentioned above, the display system 3000 can directly present a virtual image 500 formed by the image light rays CL reflected by the display modules 10, 20, and 30 on the transparent plate W, without reflection and display by other reflecting mechanisms or reflective displays. In addition, since a light path length and a reflection loss are reduced by reducing the reflecting mechanisms and the reflective displays, and an architecture that can bias the emergent light in the first direction D1 is disposed, a display picture of the same brightness or even a display picture of higher brightness can be implemented by the backlight module BL with lower luminous intensity and non-light-collecting property, such as a mini LED luminous panel according to various embodiments of the present invention. Therefore, the display modules 10, 20, and 30 and the display system 1000 or 3000 according to various embodiments of the present invention can further improve the light emergence efficiency, thereby reducing or avoiding the possible defect of excess power demand or overheating of the device while achieving the same brightness display.

As shown in FIG. 9, since the display modules 10, 20, and 30 can all emit the image light ray CL with enhanced brightness and divergent viewing angle, and can increase the probability of reflection by the transparent plate W of large area and the area of the emergent light, the brightness of the display picture can be further enhanced. As mentioned above, the image light ray CL reflected by the transparent plate W of the display modules 10, 20, and 30 disposed in different positions can be viewed in the observation region EB. By doing so, a preset object, e.g., a driver, in the observation region EB can further enhance the brightness of the viewable display information or images while ensuring the ambient field of view on the second side E2 of the transparent plate W through the transparent plate W.

Furthermore, due to the divergent light field property of the diffusion of the image light ray CL, the required virtual image 500 may have relatively high brightness and a visual range of a wider viewing angle. Therefore, in addition to the observation region EB, other regions, for example, but not limited to, a region PB1 corresponding to the position of a co-driver or a region PB2 corresponding to the position between the position of a driver and the position of the co-driver can correspondingly view the virtual image 500 (as shown in FIG. 9, the illustrative representation where the emergent light of the display module 30 is reflected to each region). As mentioned above, according to the present embodiment, the display system 3000 is essentially a display with a wide-area property. For example, the display system 3000 may be essentially a pillar-to-pillar head-up display (PHUD) that performs display on a windshield that runs through across A-pillars, and thereby, an image at a wide-area viewing angle that can be viewed from different positions can be presented by reflection by the windshield which allows a view of the external environment. Therefore, according to the present embodiment, the range of an observable region where display information or images can be viewed can be further expanded while ensuring the ambient field of view of the second side E2 of the transparent plate W, and due to the enhanced brightness of the display modules 10, 20, and 30 according to various embodiments of the present invention and the property of further divergent light rays biased along the first direction D1, the uniformity of the image light rays CL observed in different observable regions (for example, but not limited to the observation region EB, the region PB1 and the region PB2) can be improved.

According to some embodiments, the second prism layers 200 in the above display modules 10, 20, and 30 may also have different degrees of biases along the first direction D1 and angle sizes of corresponding vertex angles K2, for example, but not limited to making the angles of the vertex angles K2 in the display modules 10, 20, and 30 disposed in different positions gradually change, and thereby, the display can be adjusted for a specific observation region EB.

As mentioned above, referring to FIGS. 7 to 9, according to various embodiments of the present invention, display emergent light that diverges by bias in the first direction D1 can be implemented by a configuration where the first prism layer 100 and the second prism layer 200 are provided, and thus, a head-up display (HUD) with enhanced brightness and display effect can be implemented. In particular, according to some preferred embodiments, a head-up display with wide area or even panorama can be further implemented, for example, but not limited to, the pillar-to-pillar head-up display (PHUD), thereby allowing a specific object to view a wider display picture or objects in more locations can view the display picture. By way of examples, according to some embodiments, a full-screen display picture can be displayed under a whole windshield of the automobile, and the driver, the co-driver, passengers on back seats and the like can view the display picture with enhanced brightness and uniformity.

According to some embodiments, when the display system 3000 is integrated onto the transportation vehicle 2000, the display modules 10, 20, and 30 can be sequentially installed on an upper portion of a dashboard, but it is not limited to this. Further, according to some embodiments, it is also possible to install pivoting mechanisms with at least partial pivoting capability corresponding to each of the display modules 10, 20, and 30, and thereby, each of the display modules 10, 20, and 30 can be better slanted in the first direction D1 for displaying, so that the emergent light is incident upon the observation region EB or other regions by reflection by the transparent plate W. However, the foregoing is only illustrative, and according to some embodiments of the present invention, in a case that the dashboard does not have enough space to install the pivoting mechanism or the architectural design of the transportation vehicle 2000 is not conducive to installing the pivoting mechanism or performing pivoting, the image light ray CL that divergently exits by biasing in the first direction D1 and presents the virtual image by reflection by the transparent plate W can still be implemented according to the architecture provided by the present invention.

In summary, according to the display module and display system provided in various embodiment of the present invention, by including the first prism layer and the second prism layer that are configured in a specific arrangement, the divergent emergent light biased in a preset direction can be implemented, and the range of the emergent light viewing angle can be widened. Therefore, based on the biased emergent light, richer and more delicate application scenarios can be implemented under the cooperation of various components. For example, the head-up display with enhanced brightness and wide-area performance can be implemented in combination with the transparent plate, a loss of emergent light away from the preset direction can be reduced or avoided, and the uniformity of actual display emergent light is increased, thereby improving the overall light emergence efficiency of the display module or display system. As mentioned above, the display module or display system can be applied in various fields to provide a more intuitive and convenient display scenario.

The above are only some preferred embodiments of the present invention. It should be noted that the present invention can undergo various changes and modifications without departing from the spirit and principles of the present invention. Those skilled in the art should understand that the present invention is defined by the scope of the attached patent application, and that, in accordance with the intent of the present invention, various possible substitutions, combinations, modifications, and adaptations are not beyond the scope of the present invention defined by the scope of the attached patent application.

What is claimed is:

1. A display module, comprising:
a backlight module;
a first prism layer, disposed on the backlight module and having a plurality of first prismatic structures extending along a first direction;
a second prism layer, disposed on the first prism layer and having a plurality of second prismatic structures extending along a second direction transverse to the first direction, wherein the first prismatic structures and the second prismatic structures protrude away from the backlight module; and
a display panel, disposed on the second prism layer, and
wherein each of the first prismatic structures has a first prismatic section on a virtual plane in which the normal direction is the first direction, and each of the second prismatic structures has a second prismatic section on a virtual plane in which the normal direction is the second direction, and the first prismatic section and the second prismatic section are triangles, and
wherein the vertex of the second prismatic section has a vertical projection onto a base edge of the second prismatic section which is offset along the first direction relative to a center of the base edge.

2. The display module according to claim 1, wherein emergent light from the backlight module is at least partially biased in the first direction when passing through the second prism layer, and the display panel correspondingly generates an image light ray biased in the first direction.

3. The display module according to claim 1, wherein the first prismatic section is an isosceles triangle, and the second prismatic section is an acute triangle.

4. The display module according to claim 1, wherein the vertex angle of the second prismatic section is less than 45 degrees.

5. The display module according to claim 1, wherein the half-power full angle of an emission light field of emergent light emitted by the backlight module and sequentially passing through the first prism layer and the second prism layer is greater than 30 degrees.

6. The display module according to claim 1, wherein the light pattern of an emission light field of emergent light emitted by the backlight module and sequentially passing through the first prism layer and the second prism layer has a greater degree of divergence in the first direction than in the second direction.

7. A display system, comprising:
a transparent plate, having at least partial reflectivity;
the display module according to claim 1, disposed on a first side of the transparent plate, and the display panel forming an acute angle with the transparent plate; and
an observation region, located on the first side of the transparent plate, and farther away from the transparent plate than the display module, and
wherein the first direction runs through the transparent plate, and
wherein at least part of image light rays emitted by the display panel reach the observation region by reflection of the transparent plate, and ambient light rays from a second side of the transparent plate reach the observation region by being at least partially passing through the transparent plate.

8. The display system according to claim 7, wherein the transparent plate is a windshield of a vehicle, and the observation region is corresponding to the position of a driver.

9. The display system according to claim 7, wherein the vertex of the second prismatic section is offset away from the transparent plate along the first direction towards the observation region.

10. The display system according to claim 7, wherein the vertex angle of the second prismatic section is less than 45 degrees.

11. The display system according to claim 7, wherein the display system serves as a pillar-to-pillar head-up display (PHUD).

12. The display system according to claim 7, wherein the half-power full angle of an emission light field of emergent light emitted by the backlight module and sequentially passing through the first prism layer and the second prism layer is greater than 30 degrees.

13. The display system according to claim 7, wherein the light pattern of an emission light field of emergent light emitted by the backlight module and sequentially passing through the first prism layer and the second prism layer has a greater degree of divergence in the first direction than in the second direction.
